(19) United States
(12) Patent Application Publication
(10) Pub. No.: US 2025/0229250 A1
(43) Pub. Date: Jul. 17, 2025

(54) MAGNETIC MESOPOROUS SILICA-BASED (MMPS) MATERIALS

(71) Applicants: UNIVERSITÉ DE BOURGOGNE, Dijon (FR); CENTRE NATIONAL DE LA RECHERCHE SCIENTIFIQUE, Paris (FR)

(72) Inventors: Frédéric BOUYER, Perrigny-lès-Dijon (FR); Laroussi CHAABANE, Dijon (FR)

(21) Appl. No.: 18/850,494

(22) PCT Filed: Apr. 4, 2023
(86) PCT No.: PCT/FR2023/050476

§ 371 Date: Sep. 24, 2024

(30) Foreign Application Priority Data
Apr. 7, 2022 (FR) FR2203185

(51) Int. Cl. B01J 20/10; B01J 20/28; B01J 20/30; C02F 1/28; C02F 1/48; C02F 101/30

(52) U.S. Cl. CPC B01J 20/103; B01J 20/28007; B01J 20/28009; B01J 20/28083; B01J 20/3085; C02F 1/288; C02F 1/488; C02F 2101/30; C02F 2305/08

(57) ABSTRACT

The invention relates to a method for preparing a magnetic mesoporous silica-based (MMS) material, said method comprising the steps of: i) functionalising the silanol (—SiOH) groups of a mesoporous silica-based material by covalently grafting a ligand (L) comprising, at at least one end, a zwitterionic group of formula (I), in particular which is capable of complexing superparamagnetic particles: where n is an integer equal to 3 or 4; ii) incorporating superparamagnetic ferrite (MFe₂O₄NP) particles within the mesoporous material, by means of which a magnetic mesoporous silica-based (MMS) material is obtained.

### FIELD OF THE INVENTION

The present invention relates to a method for preparing Magnetic MesoPorous Silica-based (MMPS) materials, to Magnetic MesoPorous Silica-based (MMPS) materials able to be obtained with this method, and to the use thereof for water decontamination, in particular for the degradation of aromatic pollutants such as endocrine disruptors or pharmaceutical substances.

### TECHNICAL BACKGROUND

The presence of undesirable components in water can have harmful effects on living organisms further to direct or indirect exposure of these organisms to such substances. These components include micropollutants derived in particular from the agri-food, pharmaceutical, petroleum industries, such as pesticides, hydrocarbons, solvents, detergents, cosmetic, medicinal substances. Contamination of wastewater also derives from hospital effluent.

Bisphenol A (BPA) is one of these chemical substances periodically discharged into wastewater. This product is a primary industrial precursor in the manufacture of polycarbonates and epoxy resins. This compound is released into the environment (water, ground and air) via different routes during manufacturing processes (in particular at the time of heating, handling or conveying of the products). Over the last ten years or so, it has been included in those substances that have been listed as endocrine-disrupting by the French Agency for Food, Environmental and Occupational Health & Safety (ANSES). This is the reason why the use of this substance is being increasingly restricted.

Several types of treatments (physical, chemical or biological) are generally applied to degrade BPA contained in wastewaters, in particular degradation via advanced oxidation processes (AOPs). These processes are more efficient than usual physiochemical methods insofar as they allow the forming of highly reactive free radicals such as ·OH, ·O₂, ·O₂H capable of degrading BPA.

However, these AOPs generally require the presence of chemical reagents such as chemical oxidants (e.g. O₃, K₂Cr₂O₁) and/or catalysts (e.g. TiO₂ etc,), which increases the cost of the decontamination method and causes secondary pollution thereby further raising the cost of BPA degradation.

There is therefore a true need to provide a method with which it is possible to decontaminate water, in particular to degrade BPA, which is efficient, low-cost and especially does not cause secondary pollution.

### SUMMARY OF THE INVENTION

Magnetic mesoporous silica-based (MMPS) materials have now been discovered that are particularly useful for decontaminating water and which, in particular, overcome the aforementioned disadvantages. More specifically, the inventors have been able to show that these materials, starting from hydrogen peroxide (H₂O₂), allow the generating of highly reactive hydroxyl radicals capable of efficiently degrading BPA and/or other aromatic pollutants, and in particular of converting the same to biodegradable substances.

In addition, these catalytic materials that are chiefly silica-based are advantageously cheap to produce.

Another advantage is that these MMPS materials can easily be recovered and reused several times in several decontamination cycles. Also, aside from the non-polluting hydrogen peroxide, the use thereof does not require the presence of any chemical reagent and therefore does not generate any secondary pollution. They therefore afford access to low-cost decontamination methods that are heedful of the environment.

In a first aspect therefore, the invention concerns a method for preparing a magnetic mesoporous silica-based (MMPS) material, said method comprising the steps of:
i) Functionalising silanol groups (—SiOH) of a mesoporous silica-based material via covalent grafting of a ligand (L) comprising, at least at one end thereof, a zwitterionic group of formula (I), able in particular to complex superparamagnetic particles:

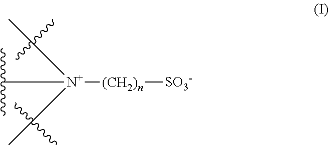

where n is an integer of 3 or 4;
ii) Incorporating superparamagnetic ferrite particles (MFe₂O₄NP) in the mesoporous material, whereby a magnetic mesoporous silica-based (MMPS) material is obtained.

According to embodiments, the method further comprises one or more of the following characteristics:
the mesoporous material is a material of SBA-15 or SBA-16 type, preferably of SBA-15 type;
the ligand (L) comprises a zwitterionic group of formula (Ia) or (Ib):

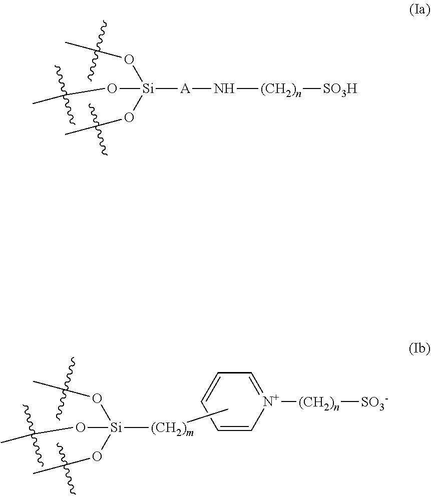

where:
m is an integer of 0, 1 or 2, and
A designates a C₃ alkylene group, or C₅ or C₆ aminoalkylene group (—NH-Alk-);
step i) comprises the following steps;
i₁) reaction of the silanol functions of the mesoporous material with a compound of formula (IIa) or (IIb):

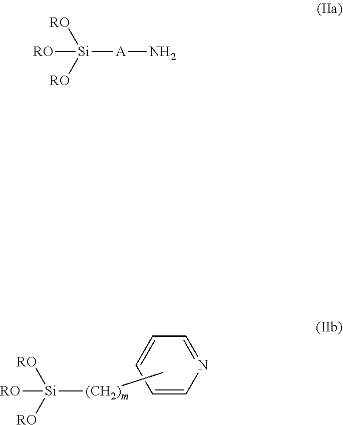

where:
R, on each occurrence, is independently a methyl or ethyl group,
m being 0, 1 or 2;
i₂) reaction of the amine or pyridine function of compound (IIa) or (IIb) with a sultone compound, in particular 1,3-propanesultone (PS) or 1,4-butanesultone;
at step ii), the superparamagnetic ferrite particles (MFe₂O₄NP) are prepared in situ, in the functionalised mesoporous material from M²⁺ ions, M²⁺ preferably being a metal cation in particular Fe²⁺ Co²⁺, Ni²⁺, Mn²⁺, Cu²⁺, Zn²⁺ and Fe³⁺;
the ferrites (MFe₂O₄NP) are prepared by reaction of M²⁺ and Fe³⁺ ions in the presence of ammonia, preferably at a temperature of 90° C.;
the superparamagnetic ferrite particles have a size of between 5 nm and 10 nm.

In a second aspect, the invention concerns a mesoporous magnetic silica-based (MMPS) material able to obtained with the method such as defined above.

In a third aspect, the invention concerns a mesoporous magnetic silica-based (MMPS) material, characterised in that it comprises:
at least one ligand (L) comprising a zwitterionic group of formula (I) as defined above, said ligand (L) being covalently grafted onto silanol groups of a mesoporous silica-based material; and
at least one nanoparticle of superparamagnetic ferrite (MFe₂O₄NPs)

In a fourth aspect, the invention concerns the use of a magnetic mesoporous silica-based material (MMPS) to decontaminate water, in particular to degrade aromatic organic compounds such as endocrine disruptors or pharmaceutical compounds.

According to embodiments, the material is used in the presence of H₂O₂ and under agitation, ultrasound in particular, preferably at high frequency.

Other characteristics, aspects, objective and advantages of the present invention will become more clearly apparent on reading the following description.

It is specified that the expressions “between . . . and . . . ” and “from . . . to . . . ” used in the present description are to be construed as including each of the indicated limits.

### BRIEF DESCRIPTION OF THE FIGURES

FIG. 1 is a schematic illustrating the synthesis of the magnetic mesoporous silica-based (MMPS) material of the invention.

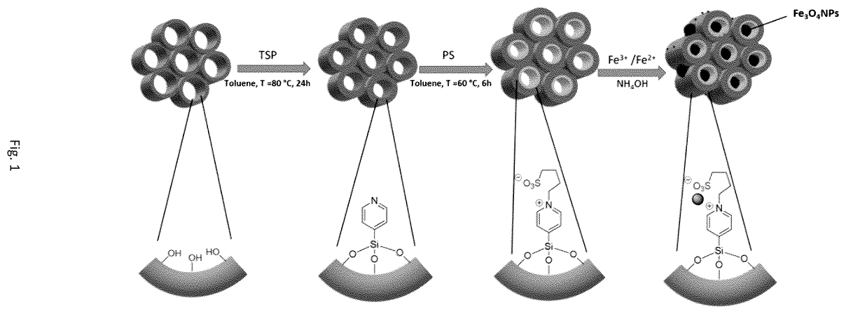

### DETAILED DESCRIPTION

The invention will now be described in more nonlimiting detail in the following description.

By “mesoporous silica-based material” or “ordered mesoporous silica (“OMS”) or “ordered mesoporous structure”, it is meant a structure composed of a scaffold in amorphous silica delimiting well-ordered channels and/or cavities of regular size. They are characterised by a pore size of 2 to 50 nm, and by a high specific surface area at times greater than 1000 m²·g⁻¹. Ordered mesoporous silicas are often synthesised according to a Cooperative Templating Mechanism (CTM) the principle of which is to hydrolyse and then condense an inorganic precursor (silane) around surfactant micelles in an aqueous solution. Depending on the type of surfactant used (ionic or non-ionic) and the reaction medium (acid or basic) in which synthesis takes place, different families of materials can be obtained (M41 S, SBA-n, HMS, MSU . . . ).

The mesoporous silica materials used in the method of the invention preferably belong to the SBA-n family (D. Zhao, J. Feng, Q. Huo, N. Melosh, G. H. Fredrickson, B. F. Chmelka, G. D. Stucky. Science. 1998, 279, 548) and more particularly to the OMS of SBA-15 or BA-16 type. This family has larger pores and thicker walls imparting greater hydrothermal stability thereto than the M41 S family generally used.

By “mesoporous material” it is meant a material including pores having a diameter of between 2 nm and 50 nm, in particular between 2 and 30 nm.

By “alkyl” or Alk, it is meant a linear or branched, saturated hydrocarbon group of formula CₙH₂ₙ₊₁ where n is the number of carbon atoms.

By “alkylene” it is meant a divalent alkyl group, -Alk-, such as methylene (—CH₂—).

### [Method for Preparing a Material (MMPS)]

In a first aspect, the invention concerns a method for preparing a magnetic mesoporous silica-based (MMPS) material, said method comprising the steps of:
i) Functionalising silanol groups (—SiOH) of a mesoporous silica-based material via covalent grafting of a ligand (L) comprising, at least at one end thereof, a zwitterionic group of formula (I), able in particular to complex superparamagnetic particles:

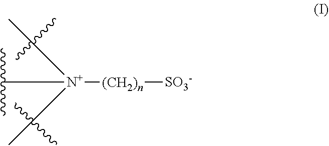

where n is an integer of 3 or 4;
ii) Incorporating superparamagnetic ferrite nanoparticles (MFe₂O₄NP) in the mesoporous material, where M can be a metal in particular Mn, Fe, Co, Ni, Cu, Zn, whereby a magnetic mesoporous silica-based (MMPS) material is obtained.

### Step i)

The mesoporous silica-based material used at step i) is preferably a material of SBA-15 or SBA.16 type, more preferably of SBA-15 type.

This material can be prepared following a method comprising the steps of:
a) Hydrolysing and precondensing a precursor of silica (SiO₂), in an acid medium in the presence of a porogen compound of formula (POE)ₙ-(POP)ₘ-(POE)ₙ where:
   POE is a polyoxyethylene block,
   POP is a polyoxypropylene block,
   n is 20 or 106, and
   m is 70;
b) Removing the porogenic agent from the condensed structure obtained at step a), after which an ordered mesoporous silica-based material (MPS) is obtained.

The porogenic agent used at step a) is either the triblock copolymer Pluronic® P123 of formula POE₂₀POP₇₀POE₂₀ or Pluronic® F127 (also called Poloxamer 407) of formula POE₁₀₆POP₇₀POE₁₀₆.

In particular, as reported in the literature, Pluronic® P123 of formula POE₂₀POP₇₀POE₂₀ allows the synthesis of Ordered Mesoporous Structures (OMS) of SBA-15 type having 2D-hexagonal structure (P6 mm), while Pluronic® F127 gives access to OMS structures of SBA-16 type having 3D-cubic structure (Im3m).

The OMS materials of SBA-15 type reported in the literature generally have large pores ranging from 50 to 300 Å that are perfectly calibrated, and are modulated by acting on the presence of pore expanders, synthesis conditions, specific surface area possibly reaching 1000 m²/g and thick walls (several nanometres), imparting good hydrothermal stability to the materials.

The OMS materials of SBA-16 type reported in the literature have similar volumetric properties to SBA-15.

The hydrolysis and precondensation step a), comprises the steps of:
a₁) dispersing the porogenic agent in an acid medium, in particular at a temperature of between 3° and 50° C.;
a₂) adding, dispersing and precondensing the silica precursor in the mixture obtained at step a₁), in particular at a temperature of between 90° C. and 150° C.

Step a₁) is particularly conducted at acid pH. The concentration of strong acid can be between 1 mol/L and 2 mol/L, in particular of about 1.6 mol/L.

The acid used at step a₁) is particularly a mineral acid such as hydrochloric acid.

Depending on embodiments, the molar concentration of the porogenic agent in water is between 3 mmol/L and 8 mmo/L, in particular between 4.5 mmo/L and 6 mmo/L.

The purpose of step a₁) is to solubilise the porogenic agent in the aqueous solution. This step is typically conducted under agitation and/or for a time tᵢ₁ of between 1 and 3 hours.

Step a₂) comprises the addition of the silica precursor to the solution of porogenic agent obtained at step a₁). This addition is generally performed under agitation.

The silica precursor can be a compound comprising at least one alkoxysilane group, preferably a compound Si(OR)₄ where R, the same or different, is a C₁-C₄ alkyl group. As examples of silica precursor, mention can be made of tetraethylorthosilicate (TEOS), tetramethoxysilane (TMOS).

The molar ratio of silica precursor to porogenic agent may vary as a function of pore size, pore volume and/or specific surface area it is desired to obtain. Preferably, it is between 50 and 200, in particular between 50 and 100.

Step a₂) can be conducted up until the formation of a dispersed solid phase, visible to the naked eye, corresponding to the formation of silica particles in suspension resulting from hydrolysis and condensation of the precursor, and translating as opacification of the reaction mixture. The progress of the turbidity of the mixture can also be continuously monitored by spectrophotometry e.g. with a turbidimeter or opacimeter.

Alternatively, step i₂) can be performed until the condensation rate of the silica precursor reaches at least 40%.

By “precursor condensation rate” it is meant the molar ratio of the number of condensed bonds to the number of condensable bonds. This condensation rate can be monitored and calculated by NMR.

As is conventional, step a₂) is performed for a time tᵢ₂ of between 1 and 3 hours.

Step b) comprises removal of the porogenic agent from the condensed structure obtained.

This removal is preferably performed by extracting the pore-forming agent via calcination.

Unlike extraction methods via chemical route, extraction via calcination allows a very high silica condensation rate to be obtained (close to 100%) which promotes stability of the silica in an aqueous medium.

Functionalisation of the silanol groups of the mesoporous material is obtained by covalently grafting a ligand (L) comprising, at least at one end thereof, a zwitterionic group of formula (I).

The ligand (L) may particularly comprise a zwitterionic group of formula (Ia) or (Ib):

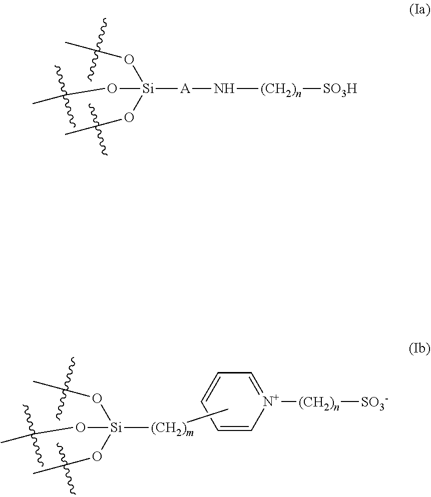

where:
m is an integer of 0, 1 or 2, preferably 0 or 2, and
A designates a C₃ alkylene group, or C₅ or C₆ aminoalkylene group (—NH-Alk-).

In formula (Ib), the nitrogen atom of the pyridinium group is preferably at ortho or para position of the silylated group (—(CH₂)ₘ—Si≡).

In formulas (Ia) or (Ib) above, the ligand (L), at one of the ends thereof, is covalently attached to the silanols of the mesoporous material via the siloxane bonds —Si—O—Si—, while the other end comprises a zwitterionic group able to complex metal ions M²⁺ such as Mn²⁺, Fe²⁺, Co²⁺, Ni²⁺, Cu²⁺, Zn²⁺ or Fe³⁺, this subsequently allowing the synthesis and/or complexing of the superparamagnetic ferrite particles.

This functionalisation at step i) preferably comprises two steps:
i₁) reaction of the silanol functions of the mesoporous material with a compound of formula (IIa) or (IIb):

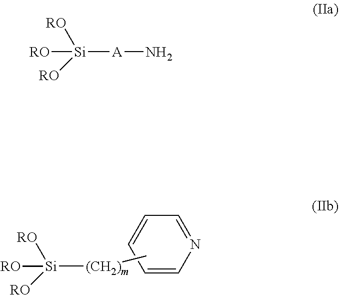

where:
R, on each occurrence, is independently a methyl or ethyl group;
A designates a C₃ alkyl group, or C₅ or C₆ aminoalkyl group;
i₂) reaction of the amine or pyridine function of compound (IIa), (IIb) with a sultone compound, in particular 1,3-propanesultone (PS) or 1,4-butanesultone.

As examples of compounds of formula (IIa), mention can be made of:
3-aminopropyltriethoxysilane (denoted APTS or APTES);
(3-aminopropyl)trimethoxysilane (denoted APTMS or APTMES);
3-aminopropyl(diethoxy)methylsilane
(also called 3-(diethoxymethylsilyl)propylamine and denoted APDMES);
(3-aminopropyl)dimethylethoxysilane (denoted APDMES);
(3-aminopropyl)methyldiethoxysilane (denoted APMDES);
N-(2-aminoethyl)-3-aminopropyltriethoxysilane (denoted AEAPTES);
N-(2-aminoethyl)-3-aminopropyltrimethoxysilane (denoted AEAPTMS), or
N-(6-aminohexyl)aminomethyltriethoxysilane (denoted AHAMTES).

As examples of compounds of formula (IIb), 2-(4-pyridylethyl)triethoxysilane, 2-(2-pyridylethyl)trimethoxysilane, 4-(triethoxysilyl)pyridine and 2-(triethoxysilyl)pyridine can be cited.

Step i₁) can be performed by heating to a temperature of between 60° C. and 100° C. in an organic solvent e.g. toluene.

Step i₂) can also be performed by heating to a temperature of between 60° C. and 100° C. in an organic solvent e.g. toluene.

### Step ii)

Step ii) corresponds to incorporation of the superparamagnetic ferrite particles MFe₂O₄ where M can be a metal, in particular Mn, Ni, Co, Fe, Cu, Zn (MFe₂O₄NP).

By “incorporation” in the meaning of the present invention, it is meant the incorporation of already-formed ferrite particles in the cavities of the mesoporous silica, or the formation of ferrite particles in situ from M²⁺ and Fe³⁺ ions within the cavities of the mesoporous silica.

In one preferred embodiment, the superparamagnetic ferrite particles (MFe₂O₄NP) are prepared in situ in the functionalised mesoporous material obtained at step i), from M(II) (with M=Mn, Ni, Co, Fe, Cu, Zn) and from Fe(III) e.g. as is the case for example with iron oxide particles Fe₃O₄NP.

The inventors have been able to observe that this embodiment is particularly advantageous since the size of the pores of the mesoporous material provides control over the growth of the ferrite nanoparticles, and in particular limits the formation of aggregates: by reducing the size of the particles (MFe₂O₄NP), the specific surface area thereof is improved and hence their catalytic property. In addition, the zwitterionic ligands allow the fixing and retaining of these nanoparticles chiefly inside the pores. As a result, the ferrite particles are less exposed and therefore less likely to be degraded by the surrounding medium, compared with a configuration in which the iron oxide nanoparticles are solely fixed on the surface of the mesoporous structure. Therefore, the magnetic properties of the material MMS are better preserved over time.

These ferrite particles can be prepared by two-step addition of M²⁺ and Fe³⁺ ions to a suspension containing the zwitterionic mesoporous silica in an ammoniacal medium, at a pH typically of between 10 and 11.

The superparamagnetic ferrite particles, in particular iron oxide particles, generally have a size of between 2 and 10 nm.

### [Materials (MMPS)]

In a second aspect, the invention concerns a magnetic mesoporous silica-based (MMPS) material able to be obtained with the method of the invention.

In a further aspect, the invention concerns a magnetic mesoporous silica-based (MMPS) material characterised in that it comprises:
at least one ligand (L) comprising a zwitterionic group of formula (I), said ligand (L) being covalently grafted onto silanol groups of a mesoporous silica-based material; and
at least one nanoparticle of superparamagnetic ferrite (MFe₂O₄NPs).

Advantageously, the characteristics of these materials such as functionalisation, content of ferrite nanoparticles, porosity, pore volume and/or specific surface area can be modulated according to the target molecule it is desired to degrade and/or the medium in which it is contained, by acting in particular on the synthesis conditions of the method of the invention.

The weight percentage of the iron oxide nanoparticles relative to silica can be between 50% and 80% in particular. This percentage can be determined for example by scanning electronic microscopy, by thermogravimetric analysis, or by ICP analysis (Inductively-Coupled Plasma spectrometry).

The specific surface area S_{BET} of the material (MMPS), measured according to the BET method, can be between 300 and 500 m²/g.

The pore volume of the material (MMPS) can be between 0.5 and 0.7 mL/g. It can be determined by nitrogen physisorption at 77K (Micromeritics ASAP 2020, USA).

The mean diameter of the pores of the material (MMPS) can be between 5 nm and 10 nm. This diameter can be measured using methods well-known in the field of mesoporous materials, and in particular by nitrogen physisorption.

### [Use of the Materials (MMPS)]

In a still further aspect, the invention concerns the use of a magnetic mesoporous silica-based (MMPS) material for water decontamination, in particular for the degradation of aromatic organic compounds such as endocrine disruptors e.g. bisphenols, or pharmaceutical compounds.

More particularly, the material can be used in the presence of H₂O₂ and under agitation, particularly by ultrasound and preferably at high frequency.

### EXAMPLES

### Example: Preparation of MMPS-Fe₃O₄NP Material

### Step 1: Synthesis of SBA-15 Silica with Pores of 10 nm

1.5 g of P123 copolymer (Aldrich, France) are dissolved in 40 mL of HCl at 2 mol/L under mechanical agitation at 40° C. for 2 h.

3.12 g of TEOS (Aldrich, France) are added dropwise to the solution under mechanical agitation. The solution is brought to 130° C. in an autoclave for 24 h.

The pH of the mixture is increased to pH 7 through the addition of sodium hydroxide (1 mol/L NaOH). The suspension is then washed several times with centrifugation/redispersion cycles until the conductivity of the suspension lies close to that of pure water (conductivity<10 μS/cm).

### Step 2: Grafting of 2-(4-pyridyl)ethyltriethoxysilane onto SBA15 Silica: SBA15-Pyr

500 mg of SBA15 are dispersed in 25 mL of anhydrous toluene. 5.437 mL of 2-(4-pyridyl)ethyltriethoxysilane (Gelest, USA) are added to the mixture. The whole is heated under reflux to 80° C. for 24 h. The powder is washed with 3 cycles of centrifugation/redispersion in ethanol. The product is dried in an oven at 60° C. for 24 h.

### Step 3: Synthesis of the Zwitterion on SBA15 Silica: SBA15-Pyr-Sult

500 mg of SBA15-pyr are dispersed in 50 mL of anhydrous toluene. 2.612 g of 1,3-propanesultone (Aldrich, France) are added to the mixture. The whole is heated under reflux at 60° C. for 6 h. The powder is washed with 3 cycles of centrifugation/redispersion in ethanol. The product is dried at ambient temperature for 24 h.

### Step 4: Adsorption of Fe²⁺ Ions on SBA15-Pyr-Sult: SBA15-Pyr-Sult-Fe²⁺

500 mg of SBA15-pyr-sult are dispersed in 50 mL of deionized water and 0.375 g of Mohr salt Fe(SO₄)₂(NH₄)₂, 6H₂O (Aldrich, France) are added. The suspension is left under agitation for 12 h at ambient temperature. The suspension is afterwards centrifuged once and the powder is dried in an oven at 60° C. overnight.

### Step 5: Preparation of SBA15-Pyr-Sult-Fe3O4

500 mg of SBA15-pyr-sult-Fe²⁺ are dispersed in 150 mL of deionised water at 80° C., and 0.750 g of FeCl₃, 6H₂O (Aldrich, France) are added to the mixture. The pH of the suspension is adjusted to a pH of between 10 and 11 through the addition of 10 mL of ammonia (NH₄OH, 2 mol/L) for 2 h. The solid is separated from the liquid by means of a magnet and washed in water and then ethanol 4 times before being dried at 80° C. overnight.

1. A method for preparing a magnetic mesoporous silica-based (MMPS) material, said method comprising the steps of:
i) functionalizing silanol groups (—SiOH) of a mesoporous silica-based material via covalent grafting of a ligand (L) comprising, at least at one end thereof, a zwitterionic group of formula (I), to complex superparamagnetic particles: 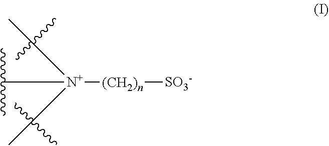
where n is an integer of 3 or 4; and
ii) incorporating superparamagnetic ferrite particles (MFe₂O₄NP with M a metal) in the mesoporous material, whereby a magnetic mesoporous silica-based (MMPS) material is obtained.

2. The method according to claim 1, wherein the mesoporous material is material of SBA-15 or SBA-16 type.

3. The method according to claim 1, wherein the ligand (L) comprises a zwitterionic group of formula (Ia) or (Ib): 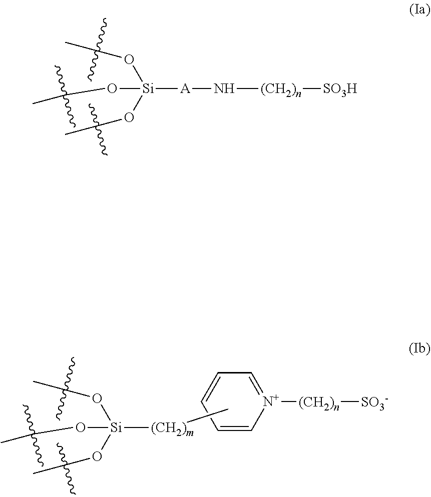
where:
m is an integer of 0, 1 or 2, and
A designates a C₃ alkylene group, or C₅ or C₆ aminoalkylene group (—NH-Alk-).

4. The method according to claim 1, wherein step i) comprises the following steps:
i₁) reaction of the silanol functions of the mesoporous material with a compound of formula (IIa) or (IIb): 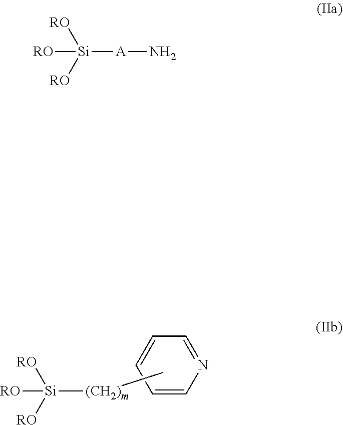
where:
R, on each occurrence, is independently a methyl or ethyl group,
m being 0, 1 or 2;
i₂) reaction of the amine or pyridine function of compound (IIa) or (IIb) with a sultone compound.

5. The method according to claim 1, wherein at step ii) the superparamagnetic ferrite particles (MFe₂O₄NP with M a metal) are prepared in situ in the functionalised mesoporous material from M²⁺ ions.

6. The method according to claim 5, wherein the ferrites (MFe₂O₄NP with M a metal) are prepared by reaction of M²⁺ and Fe³⁺ ions in the presence of ammonia.

7. The method according to claim 1, wherein the superparamagnetic ferrite particles have a size of between 5 nm and 10 nm.

8. A magnetic mesoporous silica-based (MMPS) material obtained with the method as defined in claim 1.

9. A magnetic mesoporous silica-based (MMPS) material characterised in that it comprises:
at least one ligand (L) comprising a zwitterionic group of formula (I) as defined in claim 1, said ligand (L) being covalently grafted onto silanol groups of a mesoporous silica-based material; and
at least one superparamagnetic ferrite nanoparticle (MFe₂O₄NPs with M a metal).

10. A method for decontamination of water including degradation of aromatic organic compounds or pharmaceutical compounds, comprising the addition, in the water of a magnetic mesoporous silica-based (MMPS) material according to claim 8.

11. The method according to claim 10, wherein the material is used in the presence of H₂O₂ and under agitation.

12. The method according to claim 4, wherein the sultone compound includes 1,3-propanesultone (PS) or 1,4-butanesultone.

13. The method according to claim 5, wherein the M²⁺ ions include at least one of Fe²⁺, Co²⁺, Ni²⁺, Mn²⁺, Cu²⁺, Zn²⁺ and Fe³⁺.

14. The method according to claim 6, wherein the ferrites (MFe₂O₄NP with M a metal) are prepared by the reaction of the M²⁺ and the Fe³⁺ ions in the presence of ammonia at a temperature of 90° C.

15. The method according to claim 10, wherein the material is used in the presence of H₂O₂ and under ultrasound at high frequency.

16. A method for decontamination of water including degradation of aromatic organic compounds or pharmaceutical compounds, comprising the addition, in the water of a magnetic mesoporous silica-based (MMPS) material according to claim 9.

17. The method according to claim 16, wherein the material is used in the presence of H₂O₂ and under agitation.

18. The method according to claim 16, wherein the material is used in the presence of H₂O₂ and under ultrasound at high frequency.
